(19) United States
(12) Patent Application Publication
(10) Pub. No.: US 2013/0000215 A1
(43) Pub. Date: Jan. 3, 2013

(54) ABRASIVE AGGREGATE INCLUDING SILICON CARBIDE AND A METHOD OF MAKING SAME

(75) Inventors: Guan Wang, Worcester, MA (US); Yves Boussant-Roux, Avignon (FR); Russell L. Krause, Shrewsbury, MA (US)

(73) Assignee: SAINT-GOBAIN CERAMICS & PLASTICS, INC., Worcester, MA (US)

(21) Appl. No.: 13/539,167

(22) Filed: Jun. 29, 2012

Related U.S. Application Data
(60) Provisional application No. 61/503,473, filed on Jun. 30, 2011.

(51) Int. Cl. C09K 3/14; C04B 14/04; B28B 1/08; C04B 14/32

(52) U.S. Cl. 51/308; 51/307; 264/69

(57) ABSTRACT

An abrasive article can include an abrasive aggregate with the abrasive aggregate having a plurality of silicon carbide particles bonded together by a binder material. The binder material can include a vitreous phase material, a crystalline phase material, or both. In an embodiment, the crystalline phase material can include an aluminosilicate material. In a particular embodiment, abrasive aggregates can be formed from a mixture including silicon carbide particles, a binder material, and a liquid carrier. The mixture can be formed into a number of green granules that are vibrated and heated on a platen. In an illustrative embodiment, the green granules can then be heated to form abrasive aggregates.

### PRIORITY CLAIM AND CROSS-REFERENCE TO RELATED APPLICATION

This application claims priority to U.S. Provisional Patent Application No. 61/503,473 filed on Jun. 30, 2011, and entitled “Silicon Carbide Abrasive Aggregate and a Method of Making a Silicon Carbide Abrasive Aggregate,” and naming Guan Wang et al. as inventors, which is incorporated by reference herein in its entirety.

### FIELD OF THE DISCLOSURE

This disclosure, in general, relates to abrasive particles. More particularly, the disclosure relates to abrasive aggregates that include silicon carbide and a method of forming abrasive aggregates that include silicon carbide.

### BACKGROUND

### Description of the Related Art

Abrasive articles, such as coated abrasives and bonded abrasives, are used in various industries to machine workpieces, such as by, grinding, or polishing. Machining utilizing abrasive articles spans a wide industrial scope from optics industries, automotive paint repair industries, to metal fabrication industries. In each of these examples, manufacturing facilities use abrasives to remove bulk material or affect surface characteristics of products.

For example, abrasive articles, such as abrasive segments may be used when polishing or finishing certain various types of workpieces, including, for example, metal, wood, or stone. In particular instances, abrasive segments containing abrasive grit contained within a binder material may be used to effectively finish stone. However, the industry continues to demand improvements in abrasive technologies.

### SUMMARY

In one aspect, the disclosure is directed to an abrasive article including an abrasive aggregate. The abrasive aggregate can include a plurality of silicon carbide particles bonded together by a binder material. The binder material can include a vitreous phase material and a crystalline phase material. In an embodiment, the crystalline phase material can include an aluminosilicate material.

In another aspect, the disclosure is directed to a method of making an abrasive aggregate. The method can include forming a mixture including silicon carbide particles, a binder material, and a liquid carrier. In addition, the method can include placing green granules including at least a portion of the silicon carbide particles from the mixture, at least a portion of the binder material from the mixture, and at least a portion of the liquid carrier from the mixture on a platen while the platen is vibrated and heated.

The above and other features described herein including various details of construction and combinations of parts, and other advantages, will now be more particularly described with reference to the accompanying drawings and pointed out in the claims. It will be understood that the particular method and article embody certain features that are shown by way of illustration and not as limitations and that the principles and features described herein may be employed in various and numerous embodiments.

### BRIEF DESCRIPTION OF THE DRAWINGS

The present disclosure may be better understood, and its numerous features and advantages made apparent to those skilled in the art by referencing the accompanying drawings.

FIG. 1 includes a diagram of a system to make abrasive aggregates including silicon carbide in accordance with an embodiment.

FIG. 2 includes a first scanning electron microscope (SEM) image of a portion of an abrasive aggregate including silicon carbide in accordance with an embodiment.

FIG. 3 includes a second SEM image of a portion of an abrasive aggregate including silicon carbide in accordance with an embodiment.

FIG. 4 includes a third SEM image of a portion of an abrasive aggregate including silicon carbide in accordance with an embodiment.

FIG. 5 includes a fourth SEM image of a portion of an abrasive aggregate including silicon carbide in accordance with an embodiment.

FIG. 6 includes a fifth SEM image of a portion of an abrasive aggregate including silicon carbide in accordance with an embodiment.

FIG. 7 includes a flow chart illustrating a method of making an abrasive segment in accordance with an embodiment.

FIG. 8 includes a front plan view of an abrasive segment in accordance with a first embodiment.

FIG. 9 includes a side plan view of the abrasive segment of FIG. 8 in accordance with the first embodiment.

FIG. 10 includes a front plan view of an abrasive segment in accordance with a second embodiment.

FIG. 11 includes a side plan view of the second embodiment of the abrasive segment in accordance with an embodiment of FIG. 10.

FIG. 12 includes a first SEM image of a portion of an abrasive segment in accordance with an embodiment.

FIG. 13 includes a second SEM image of a portion of an abrasive a segment in accordance with an embodiment.

FIG. 14 includes a flow chart illustrating a method of polishing a workpiece in accordance with an embodiment.

FIG. 15 includes a bar chart illustrating weight loss and surface roughness of a workpiece after conducting a polishing process in accordance with an embodiment.

FIG. 16 includes a bar chart illustrating weight loss and surface roughness of a workpiece after conducting a polishing process in accordance with an embodiment.

FIG. 17 includes a bar chart illustrating weight loss and surface roughness of a workpiece after conducting a polishing process in accordance with an embodiment.

FIG. 18 includes a first SEM image for a used abrasive segment containing abrasive grits.

FIG. 19 includes a second SEM image for a used abrasive segment containing abrasive aggregates in accordance with an embodiment.

### DETAILED DESCRIPTION

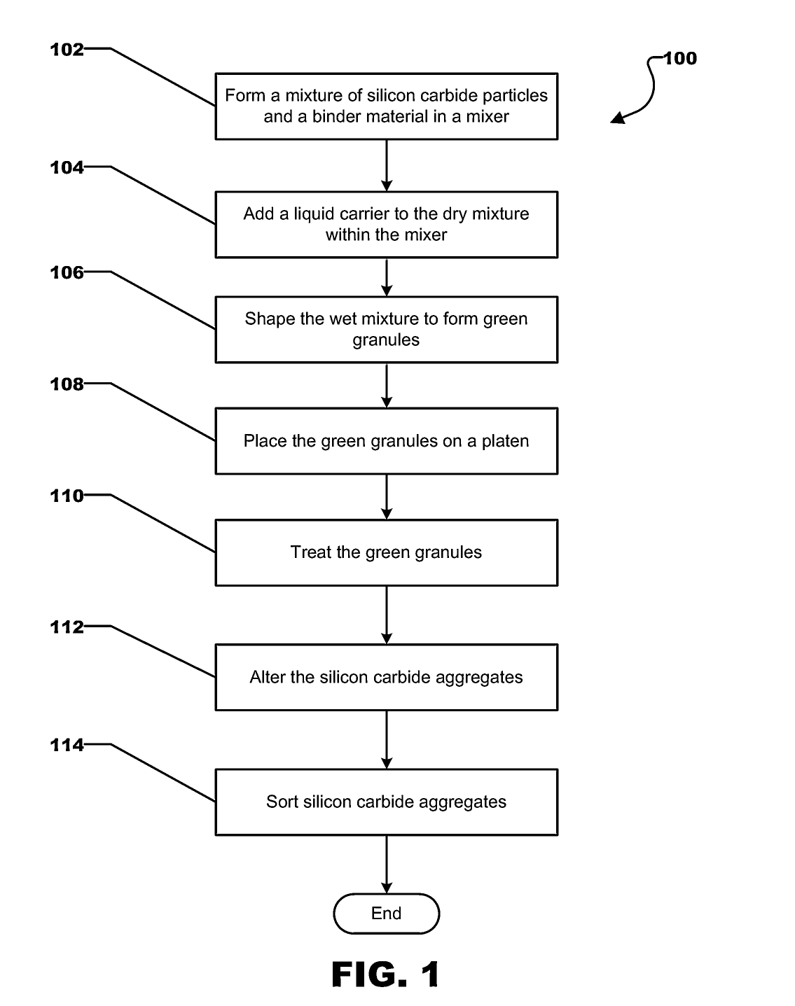

Referring initially to FIG. 1, a method of making abrasive aggregates is shown and is generally designated 100. The method 100 commences at 102 by forming a mixture of silicon carbide particles and a binder material in a mixer. In a particular aspect, the mixer may be a paddle mixer. The paddle mixer may include a high shear Eirich mixer or a Rippon mixer. At 102, the silicon carbide particles and the binder material can be dry mixed in order to form a dry mixture and can be mixed to uniformly disperse the components relative to each other.

In a particular aspect, the silicon carbide particles and the binder material may be mixed for at least about 2 minutes. In another aspect, the silicon carbide particles and the binder material may be mixed for at least about 3 minutes, such as at least about 4 minutes, or even at least about 5 minutes. In another aspect, the silicon carbide particles and the binder material may be mixed for no greater than about 30 minutes, such as no greater than about 25 minutes, no greater than about 20 minutes, or even no greater than about 15 minutes. It will be appreciated that the mixing time can be within a range between any of the minimum and maximum times noted above.

In a particular aspect, the silicon carbide particles can include silicon carbide particles having an average primary particle size of at least about 0.5 microns. In another aspect, the silicon carbide particles can include silicon carbide particles having an average primary particle size of at least about 1 micron, at least about 10 microns, at least about 20 microns, at least about 30 microns, at least about 40 microns, or even at least about 50 microns. In another aspect, the silicon carbide particles can include silicon carbide particles having an average primary particle size of no greater than about 1500 microns, such as no greater than about 1200 microns, no greater than about 1000 microns, no greater than about 500 microns, no greater than about 300 microns, or even no greater than about 100 microns. It will be appreciated that the average particle size of the silicon carbide particles can be within a range between any of the minimum and maximum dimensions noted above.

In another particular aspect, the binder material can include a frit material which is suitable for forming an amorphous material (i.e., a glass material) after further processing. Further, the frit material may include an oxide. The oxide may include a silicate. Moreover, the oxide may include an alkali material, an alkaline earth material, or a combination thereof. In another aspect at least a portion of the oxide may include sodium. Further, the oxide may consist essentially of a sodium silicate.

In some instances, the dry mixture can include at least about 0.5 wt % of a frit material for a total weight of the dry mixture, at least about 3 wt % of a frit material for a total weight of the dry mixture, or at least about 5 wt % of a frit material for a total weight of the dry mixture. In other situations, the dry mixture can include no greater than about 15 wt % of a frit material for a total weight of the dry mixture, no greater than about 10 wt % of a frit material for a total weight of the dry mixture, or no greater than about 7 wt % of a frit material for a total weight of the dry mixture. It will be appreciated that the amount of frit material can be within a range between any of the minimum and maximum percentages noted above.

In one embodiment, the binder material can also include an organic material. For example, the binder material can include a polymeric component. In a particular illustrative embodiment, the organic material can include dextrin.

In an embodiment, the dry mixture can include at least about 0.5 wt % of an organic material for a total weight of the dry mixture, at least about 3 wt % of an organic material for a total weight of the dry mixture, or at least about 5 wt % of an organic material for a total weight of the dry mixture. In other situations, the dry mixture can include no greater than about 15 wt % of an organic material for a total weight of the dry mixture, no greater than about 10 wt % of an organic material for a total weight of the dry mixture, or no greater than about 7 wt % of an organic material for a total weight of the dry mixture. It will be appreciated that the amount of organic material can be within a range between any of the minimum and maximum percentages noted above.

In another aspect, the binder material may also include an inorganic mineral component, such as clay, which may be a crystalline material. The inorganic mineral component may include an oxide or a hydroxide. Further, the inorganic mineral component may include an alkali material, an alkaline earth material, alumina, silica, or a combination thereof. In a particular aspect, the inorganic mineral component may include a silicate. Further, the inorganic mineral component may include an alumina silicate. In another aspect, the inorganic mineral component can include an aluminum silicate hydroxide, which may be referred to as a kaolin clay. Further, the inorganic mineral component may consist essentially of a kaolin clay.

In a particular aspect, the binder material can include at least about 50 wt % sodium silicate for the total weight of the binder material. For example, the binder material can include, at least about 60 wt % sodium silicate, or even at least about 70 wt % sodium silicate. In another aspect, the binder material may include no greater than about 100 wt % sodium silicate, such as no greater than about 90 wt % sodium silicate, or even no greater than about 75 wt % sodium silicate. It will be appreciated that the amount of sodium silicate can be within a range between any of the minimum and maximum percentages noted above.

In another particular aspect, the binder material can include at least about 50 wt % aluminum silicate hydroxide for the total weight of the binder material, such as at least about 60 wt % aluminum silicate hydroxide, or even at least about 70 wt % aluminum silicate hydroxide. In yet another aspect, the binder material may include no greater than about 100 wt % aluminum silicate hydroxide, such as no greater than about 90 wt % aluminum silicate hydroxide, or even no greater than about 75 wt % aluminum silicate hydroxide. It will be appreciated that the amount of aluminum silicate hydroxide can be within a range between any of the minimum and maximum percentages noted above.

Moving to 104, a liquid carrier may be added to the dry mixture within the mixer. Thereafter, the liquid carrier and the dry mixture may be mixed to form a wet mixture that includes silicon carbide particles, the binder material, and the liquid carrier.

In a particular aspect, the liquid carrier may be aqueous. Further, in a particular aspect, the ratio of dry mixture to liquid carrier may be at least about 15:1, such as at least about 17:1, at least about 18:1, or even at least about 19:1. Moreover, in another aspect, the ratio of dry mixture to liquid carrier may be no greater than about 30:1, such as no greater than about 25:1, or even no greater than about 20:1. It will be appreciated that the ratio of dry mixture to liquid carrier can within a range between any of the minimum and maximum ratios noted above.

In an embodiment, the wet mixture can include at least about 0.5 wt % of a liquid carrier for a total weight of the wet mixture, at least about 3 wt % of a liquid carrier for a total weight of the wet mixture, or at least about 5 wt % of a liquid carrier for a total weight of the wet mixture. In other cases, the wet mixture can include no greater than about 18 wt % of a liquid carrier for a total weight of the wet mixture, no greater than about 12 wt % of a liquid carrier for a total weight of the wet mixture, or no greater than about 9 wt % of a liquid carrier for a total weight of the wet mixture. It will be appreciated that the amount of the liquid carrier can within a range between any of the minimum and maximum ratios noted above.

In another particular aspect, the dry mixture and the liquid carrier may be mixed for at least about 2 minutes, such as at least about 3 minutes, at least about 4 minutes, or even at least about 5 minutes. In another aspect, the dry mixture and the liquid carrier may be mixed for no greater than about 30 minutes, such as no greater than about 25 minutes, no greater than about 20 minutes, or even no greater than about 15 minutes. It will be appreciated that the mixing time of the dry mixture and the liquid carrier can be within a range between any of the minimum and maximum times noted above. In a particular illustrative embodiment, the dry mixture and the liquid carrier may be mixed for a duration within a range of about 4 minutes to about 12 minutes.

At 106, the method 100 may include shaping the wet mixture to form green granules. In a particular aspect, the wet mixture may be shaped into green granules by screening, pressing, sieving, extruding, segmenting, casting, stamping, cutting, or a combination thereof. In particular, the wet mixture may be shaped into the green granules by pushing, or otherwise moving, the wet mixture through a screen. In an illustrative embodiment, a vibratory screening machine can be utilized to carry out the shaping operation.

In a particular aspect, the screen can include a US mesh size of at least about 8, such as at least about 10, such as at least about 12, or even at least about 14. In another aspect, the screen can include a US mesh size no greater than about 25, such as no greater than about 20, no greater than about 18, or even no greater than about 16. It will be appreciated that the screen size can include a range between any of the minimum and maximum values noted above.

After forming the green granules, at 108, the green granules may be placed on a platen. For example, the green granules may fall through a hopper onto the platen. In a particular aspect, the platen may include a vibratory hot table that is vibrated and heated. The heated and vibrated platen may serve to stabilize the green granules.

In a particular embodiment, the green granules may remain on the platen for at least about 5 minutes. In another aspect, the green granules may remain on the platen for at least about 10 minutes or even at least about 15 minutes. In another aspect, the green granules may remain on the platen for no greater than about 60 minutes, such as no greater than about 30 minutes, no greater than about 25 minutes, or even no greater than about 20 minutes. It will be appreciated that the green granules may remain on the platen for a time in a range between any of the minimum and maximum times noted above.

The platen can be heated to a temperature of at least about 80° C. to heat the green granules thereon. In another aspect, the platen can be heated to a temperature of at least about 85° C., at least about 110° C., or even at least about 150° C. In another aspect, the platen may be heated to a temperature no greater than about 300° C., such as no greater than about 250° C., or even no greater than about 200° C. It will be appreciated that the platen can be heated to a temperature that can be within a range between any of the minimum and maximum temperatures noted above. In an illustrative embodiment, the platen can be heated at a temperature within a range of about 150° C. to about 250° C.

The platen may oscillate at a frequency of at least about 10 cycles per second. In another aspect, the platen may oscillate at a frequency of at least about 20 cycles per second, or even at least about 30 cycles per second. Further, in another aspect, the platen may oscillate at a frequency no greater than about 180 cycles per second, no greater than about 150 cycles per second, no greater than about 90 cycles per second, or even no greater than about 45 cycles per second. It will be appreciated that the platen can oscillate at a frequency in a range between any of the minimum and maximum values noted above.

After completing the processes at 106 and 108, the method 100 can continue to 110, where the method 100 may include treating the green granules to form abrasive aggregates that include silicon carbide. Treating the green granules may include the application of temperature, the application of pressure, or the application of a chemical to facilitate a physical change in the green granules. The application of temperature may include a cooling process or a heating process. Further, treating the green granules may include sintering or densifying the green granules. For example, treating the green granules may include transferring the green granules to a kiln. In a particular aspect, the kiln may be a kiln that moves in a linear direction. For example, the kiln may be a tunnel kiln in which a belt or a cart may move through a heated tunnel in a linear direction. It is to be understood that the kiln may not necessarily rotate, or otherwise continuously tumble, the green granules onto each other. In particular, the kiln may be a Harper kiln. In certain situations, the kiln can include plates as a transport medium. In other situations, the kiln can include saggers as a transport medium.

The stabilized green granules may move through the kiln linearly at a rate of at least about 1.0 feet per hour. In another aspect, the stabilized green granules may move through the kiln at a rate of at least about 1.5 feet per hour, such as at least about 2.0 feet per hour, or even at least about 3.0 feet per hour. In still another aspect, the stabilized green granules may move through the kiln at a rate of no greater than about 6 feet per hour, such as no greater than about 5 feet per hour, no greater than about 4.0 feet per hour, or even no greater than about 3.5 feet per hour. It will be appreciated that the rate at which the green granules move through the kiln can be within a range between any of the minimum and maximum rates noted above.

It may be appreciated that the stabilized green granules may be sintered within the kiln to form abrasive aggregates including silicon carbide. In a particular aspect, the stabilized green granules are sintered for at least about 0.25 hours, at least about 0.5 hours, such as at least about 1.0 hours, or even at least about 1.5 hours. In yet another aspect, the stabilized green granules are sintered for no greater than about 3.0 hours, such as no greater than 2.5 hours, or even no greater than 2.0 hours. It will be appreciated that the sintering time can be within a range between any of the minimum and maximum times noted above. In an illustrative embodiment, the sintering operation can have a duration within a range of about 30 minutes to about 50 minutes.

Further, in a particular aspect, the stabilized green granules can be sintered at a temperature of at least about 500° C. In another aspect, the stabilized green granules can be sintered at a temperature of at least about 600° C., such as at least about 700° C., at least about 800° C., or even at least about 900° C. In another aspect, the stabilized green granules can be sintered at a temperature no greater than about 1200° C., such as no greater than 1100° C., or even no greater than 1000° C. It will be appreciated that the sintering temperature can be within a range between any of the minimum and maximum temperatures noted above. In an illustrative embodiment, the sintering temperature can be within a range of about 925° C. to about 975° C.

In another particular aspect, the kiln may include a particular sintering atmosphere. The sintering atmosphere may comprise an inert gas including, for example, neon, argon, nitrogen, or a combination thereof.

After completing the treating process at 110, the method 100 can continue at 112 by altering the silicon carbide aggregates. Altering the silicon carbide aggregates may include sizing the silicon carbide aggregates. For example, sizing can include crushing the silicon carbide aggregates in a crusher to yield crushed silicon carbide aggregates. For example, the crusher may be a jaw crusher. However, another suitable type of crusher may be used to crush the silicon carbide aggregates.

Further, in a particular aspect, the silicon carbide aggregates may be crushed at a temperature of at least about 15° C. In another aspect, the silicon carbide aggregates may be crushed at a temperature of at least about 20° C., or even at least about 25° C. In another aspect, the silicon carbide aggregates may be crushed at a temperature no greater than about 40° C., such as no greater than about 35° C., or even no greater than about 30° C. It will be appreciated that the crush temperature can be within a range between any of the minimum and maximum temperatures noted above.

After the altering operation performed at 112, the method 100 may continue at 114 with sorting the altered silicon carbide aggregates. The sorting process undertaken at 114 may include sorting the altered silicon carbide aggregates by size, shape, or a combination thereof. Further, the sorting process may include sieving the altered silicon carbide aggregates.

In a particular embodiment, as shown in FIG. 1, the altered silicon carbide aggregates may be screened in order to sort the silicon carbide aggregates into one or more different abrasive grit sizes using one or more mesh screens.

Thereafter, a sorted product may be provided to a user. Alternatively, the sorted product may be further processed and transformed into an abrasive article, such as an abrasive segment, described herein. As used herein, the term abrasive aggregate can refer to a sorted product, a silicon carbide aggregate, an altered silicon carbide aggregate, a crushed sintered silicon carbide aggregate, a crushed abrasive aggregate, or a combination thereof.

It can be appreciated that the sorted product can include crushed sintered silicon carbide aggregates. In a particular aspect, the crushed sintered silicon carbide aggregates may have an average aggregate size of at least about 50 microns, such as at least about 100 microns, at least about 250 microns, or even at least about 500 microns. Further, the crushed sintered silicon carbide aggregates may have an average aggregate size no greater than about 5000 microns, such as no greater than about 2500 microns, or even no greater than about 1000 microns. It will be appreciated that the average aggregate size can be within a range between any of the minimum and maximum sizes noted above. In a particular illustrative embodiment, the crushed sintered silicon carbide aggregates can have an average aggregate size within a range of about 200 microns to about 850 microns.

Each abrasive aggregate may include at least about 50 wt % silicon carbide particles for the total weight of the abrasive aggregate. In another aspect, each silicon carbide aggregate may incorporate at least about 55 wt % silicon carbide particles, such as at least about 60 wt % silicon carbide particles, at least about 65 wt % silicon carbide particles, at least about 70 wt % silicon carbide particles, or even at least about 75 wt % silicon carbide particles. In still another aspect, each abrasive aggregate may have no greater than about 99 wt % silicon carbide particles, such as no greater than about 95 wt % silicon carbide particles, or even no greater than about 90 wt % silicon carbide particles. It will be appreciated that the amount of silicon carbide particles for the total weight of the abrasive aggregate may be within a range between any of the minimum and maximum percentages noted above.

Each abrasive aggregate can include a minor amount (as measured by wt %) of a binder material. For example, the abrasive aggregate can include no greater than about 50 wt % binder material for the total weight of the abrasive aggregate. In another aspect, each abrasive aggregate may include no greater than about 40 wt % binder material, such as no greater than about 35 wt % binder material, no greater than about 30 wt % binder material, no greater than about 25 wt % binder material, no greater than about 20 wt % binder material, no greater than about 15 wt % binder material, or even no greater than about 10 wt % binder material. In another aspect, each abrasive aggregate may include at least about 1.0 wt % binder material, such as at least about 1.5 wt % binder material, at least about 2.0 wt % binder material, at least about 2.5 wt % binder material, or even at least about 5.0 wt % binder material. It will be appreciated that the amount of binder material for the total weight of the abrasive aggregate may be within a range between any of the minimum and maximum percentages noted above. In a particular illustrative embodiment, the abrasive aggregates can include binder material within a range of about 1.5 wt % to about 7 wt % for the total weight of the abrasive aggregate.

The abrasive aggregate can include a particular ratio of silicon carbide particles to binder material. For example, the ratio of silicon carbide particles to binder material can be at least about 1:1. In another aspect, the ratio of silicon carbide particles to binder material can be at least about 1.2:1, such as at least about 1.5:1, at least about 1.9:1, at least about 2.3:1, or even at least about 3.0:1. In another aspect, the ratio of silicon carbide particles to binder material within the abrasive aggregate is no greater than about 10:1, no greater than about 15:1, no greater than about 25:1, or even no greater than about 40:1. It will be appreciated that the ratio of silicon carbide particles to binder material may be within a range between any of the minimum and maximum ratios noted above.

In another aspect of the present disclosure, the binder material of the abrasive aggregates may include a vitreous phase material. Further, the binder material of each of the abrasive aggregates can include at least about 50 wt % vitreous phase material for the total weight of the binder material, such as at least about 60 wt % vitreous phase material for the total weight of the binder material, or even at least about 75 wt % vitreous phase material for the total weight of the binder material. In yet another aspect, the binder material of each of the abrasive aggregates can include no greater than about 100 wt % vitreous phase material for the total weight of the binder material, no greater than about 95 wt % vitreous phase material for the total weight of the binder material, or even no greater than about 90 wt % vitreous phase material for the total weight of the binder material. It will be appreciated that the amount of vitreous phase material may be within a range between any of the minimum and maximum percentages noted above.

In an embodiment, the vitreous phase material can include silica. In some instances, the vitreous phase material can include materials other than silica, such as an alkali material, an alkaline earth material, an aluminum containing material, or a combination thereof. In a particular embodiment, the vitreous phase material can include Na₂O, CaO, Al₂O₃, or a combination thereof.

In one embodiment, the vitreous phase material can include at least about 68 wt % silica for a total weight of the vitreous phase material, at least about 71 wt % silica for a total weight of the vitreous phase material, or at least about 75 wt % silica for a total weight of the vitreous phase material. In other aspects, the vitreous phase material can include no greater than about 84 wt % silica for a total weight of the vitreous phase material, no greater than about 81 wt % silica for a total weight of the vitreous phase material, or no greater than about 78 wt % silica for a total weight of the vitreous phase material. It will be appreciated that the amount of silica in the vitreous phase material can be within a range between any of the minimum and maximum percentages noted above.

In another particular aspect of the present disclosure, the binder material of each of the abrasive aggregates can include at least about 50 wt % crystalline phase material for the total weight of the binder material. In another aspect, the binder material of each of the abrasive aggregates can include at least about 60 wt % crystalline phase material for the total weight of the binder material, or even at least about 75 wt % crystalline phase material for the total weight of the binder material. Further, in another aspect, the binder material of each of the abrasive aggregates may include no greater than about 100 wt % crystalline phase material for the total weight of the binder material, no greater than about 95 wt % crystalline phase material for the total weight of the binder material, or even no greater than about 90 wt % crystalline phase material for the total weight of the binder material. It will be appreciated that the amount of crystalline phase material may be within a range between any of the minimum and maximum values noted above.

In a particular aspect, the crystalline phase material may include an oxide. Suitable oxides can include silica. In another aspect, the oxide may include alumina. In yet another aspect, the oxide may include an aluminosilicate. Moreover, in another aspect, the oxide may include alkali or alkaline earth elements. The oxide may include sodium, and particularly, the oxide may include sodium aluminosilicate. In one particular embodiment, the oxide may consist essentially of sodium aluminosilicate.

In another particular aspect, the crystalline phase material can include crystallites having an average crystallite size of at least about 2 microns, such as at least about 5 microns, or even at least about 10 microns. In another aspect, the crystalline phase material can include crystallites having an average crystallite size no greater than about 100 microns, such as no greater than about 75 microns, no greater than about 50 microns, or even no greater than about 25 microns. It will be appreciated that the average crystallite size may be within a range between any of the minimum and maximum sizes noted above.

The abrasive aggregates may include a porosity of at least about 1 vol % of a total volume of the abrasive aggregates. In another aspect, the abrasive aggregates may include a porosity of at least about 3 vol %, such as at least about 5 vol %, at least about 6 vol %, at least about 7 vol %, at least about 8 vol %, at least about 9 vol %, or even at least about 10 vol %. Further, in another aspect, the abrasive aggregates may include a porosity no greater than about 60 vol %, no greater than about 50 vol %, or even no greater than about 30 vol %. It will be appreciated that the porosity of the abrasive aggregates may be within a range between any of the minimum and maximum percentages noted above.

In a particular embodiment, the pores may be positioned within the binder material between adjacent silicon carbide particles. In a particular embodiment, at least about 10% of the pores may be positioned within the binder material between adjacent silicon carbide particles, such as at least about 15%, at least about 20%, or even at least about 25%. Further, no greater than about 50% of the pores may be positioned within the binder material between adjacent silicon carbide particles, no greater than about 45%, or even no greater than about 40%. It will be appreciated that the amount of pores positioned between adjacent silicon carbide particles may be within a range between any of the minimum and maximum percentages noted above.

The pores can have an average pore size of at least about 1 micron. Further, the pores can have an average pore size of at least about 2 microns, such as at least about 3 microns, at least about 4 microns, or at least about 5 microns. The pores can have an average pore size no greater than about 10 microns, no greater than about 15 microns, or even no greater than about 20 microns. It will be appreciated that the average pore size may be within a range between any of the minimum and maximum sizes noted above.

In particular, the porosity may be preferentially disposed within the binder material of the abrasive aggregates. For example the binder material of the abrasive aggregates may include a porosity of at least about 1 vol % of a total binder material volume. In another aspect, the binder material of each abrasive aggregate may include a porosity of at least about 2 vol %, such as at least about 3 vol %, at least about 4 vol %, or at least about 5 vol %. Further, the binder material of the abrasive aggregates may include a porosity no greater than about 60 vol %, no greater than about 50 vol %, and even no greater than about 25 vol %. It will be appreciated that the porosity of the binder material may be within a range between any of the minimum and maximum percentages noted above.

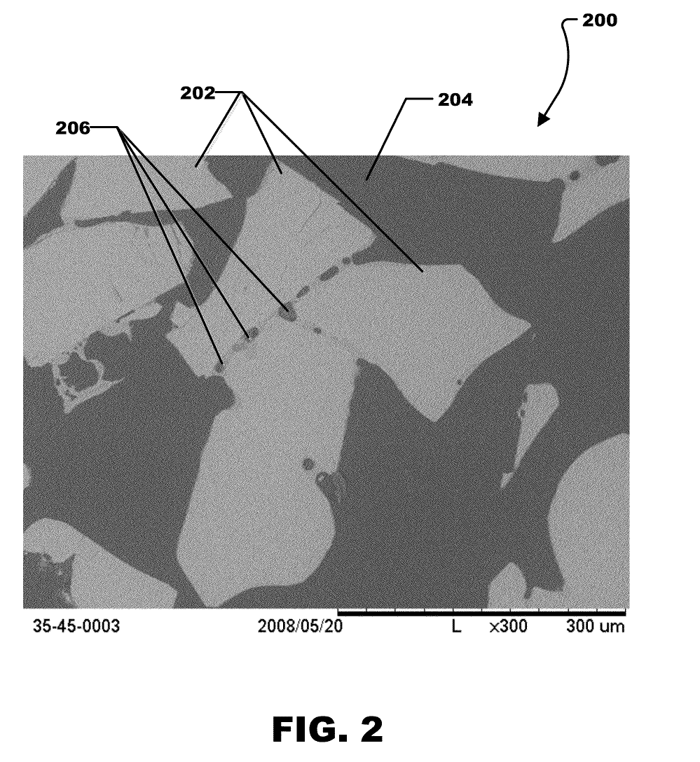

Referring to FIG. 2 through FIG. 6, several scanning electron microscope (SEM) images of abrasive aggregates are shown according to embodiments described herein. FIG. 2 depicts an SEM image, generally designated 200, of an abrasive aggregate comprising silicon carbide particles having a grit size of approximately 190 microns according to an embodiment. The SEM image 200 of FIG. 2 was taken at a magnification of 300× and shows a portion of an abrasive aggregate. As shown, the abrasive aggregate includes silicon carbide particles 202 contained within a binder material 204.

Further, the abrasive aggregate includes a plurality of pores 206. As shown, the pores 206 may be positioned within the binder material 204 between adjacent silicon carbide particles 202. In a particular embodiment, at least about 10% of the pores 206 may be positioned within the binder material 204 between adjacent silicon carbide particles 202, such as at least 15%, at least about 20%, or even at least about 25%. Further, no greater than about 50% of the pores 206 may be positioned within the binder material 204 between adjacent silicon carbide particles 202, no greater than about 45%, or even no greater than about 40%. It will be appreciated that the percentage of pores positioned between adjacent silicon carbide particles may be in a range between any of the minimum and maximum values noted above.

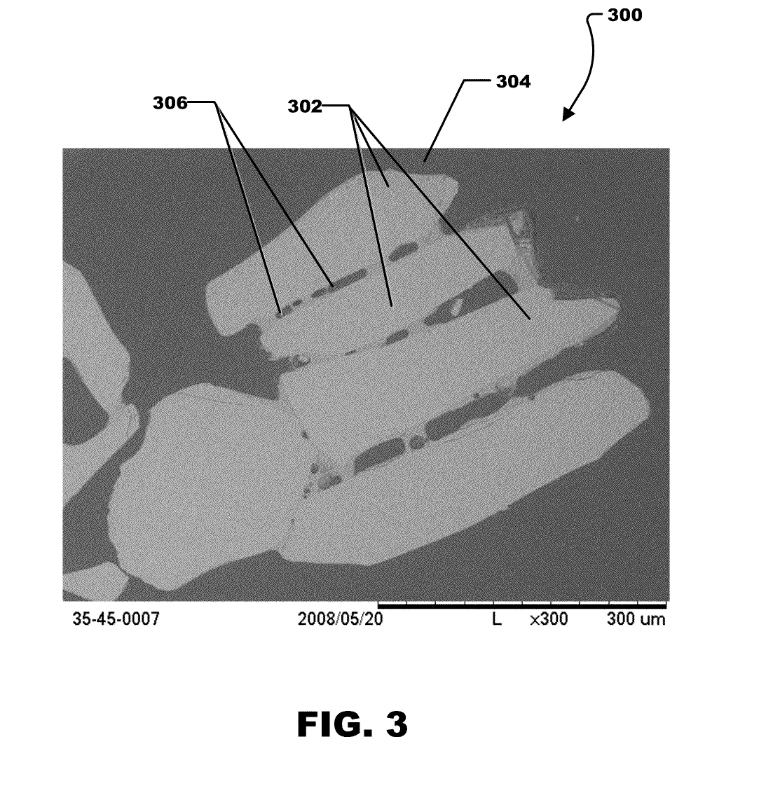

FIG. 3 depicts another SEM image, generally designated 300, of an abrasive aggregate comprising silicon carbide particles having a grit size of approximately 190 microns according to an embodiment. The SEM image 300 of FIG. 3 was also taken at a magnification of 300× and shows a portion of an abrasive aggregate. As shown, the abrasive aggregate includes silicon carbide particles 302 contained within binder material 304. Further, the abrasive aggregate includes a plurality of pores 306. As shown, multiple pores 306 may be substantially aligned along a boundary between adjacent silicon carbide particles 302.

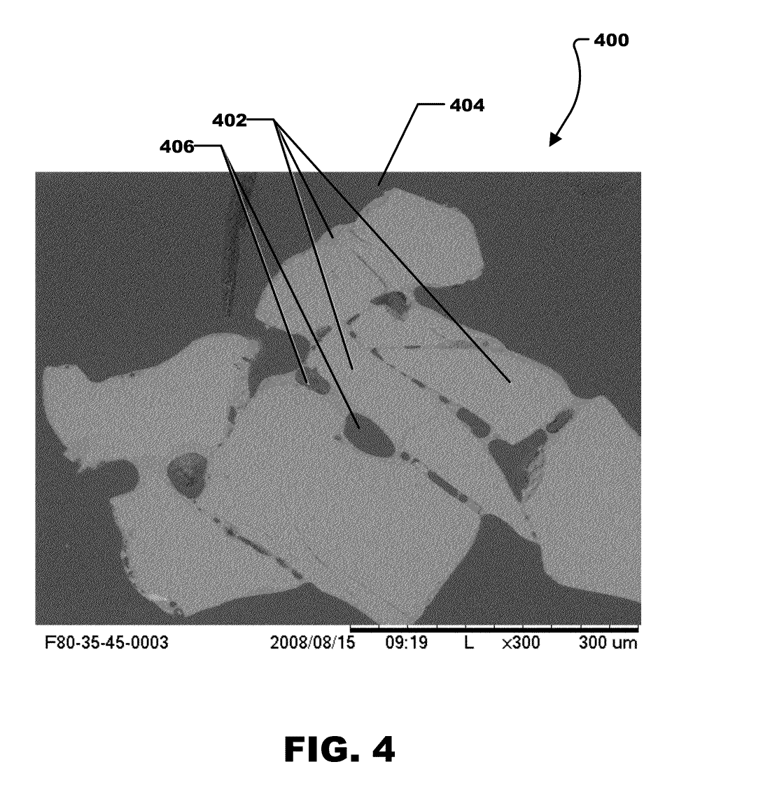

Referring to FIG. 4, another SEM image that is generally designated 400 is shown. As shown, the SEM image 400 is an image of an abrasive aggregate comprising silicon carbide particles having a grit size of approximately 190 microns according to an embodiment. The SEM image 400 of FIG. 4 was taken at a magnification of 300× and shows a portion of an abrasive aggregate. As shown, the abrasive aggregate includes silicon carbide particles 402 contained within a binder material 404. Further, the abrasive aggregate includes a plurality of pores 406.

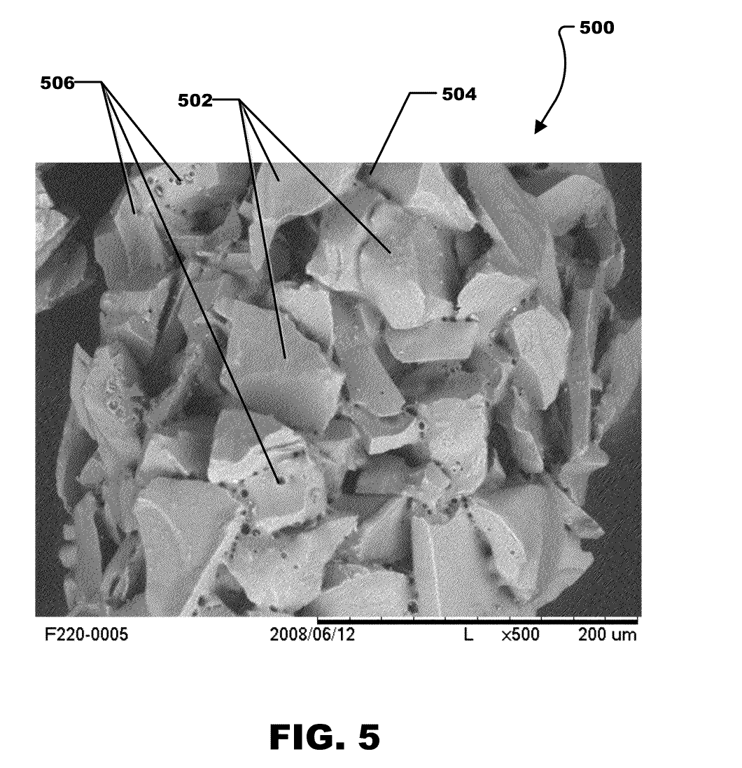

FIG. 5 depicts yet another SEM image, generally designated 500, of an abrasive aggregate comprising silicon carbide particles having a grit size of approximately 63 microns according to an embodiment. The SEM image 500 of FIG. 5 was taken at a magnification of 500× and shows a portion of an abrasive aggregate. As shown, the abrasive aggregate includes silicon carbide particles 502 contained within a binder material 504. Further, the abrasive aggregate includes a plurality of pores 506.

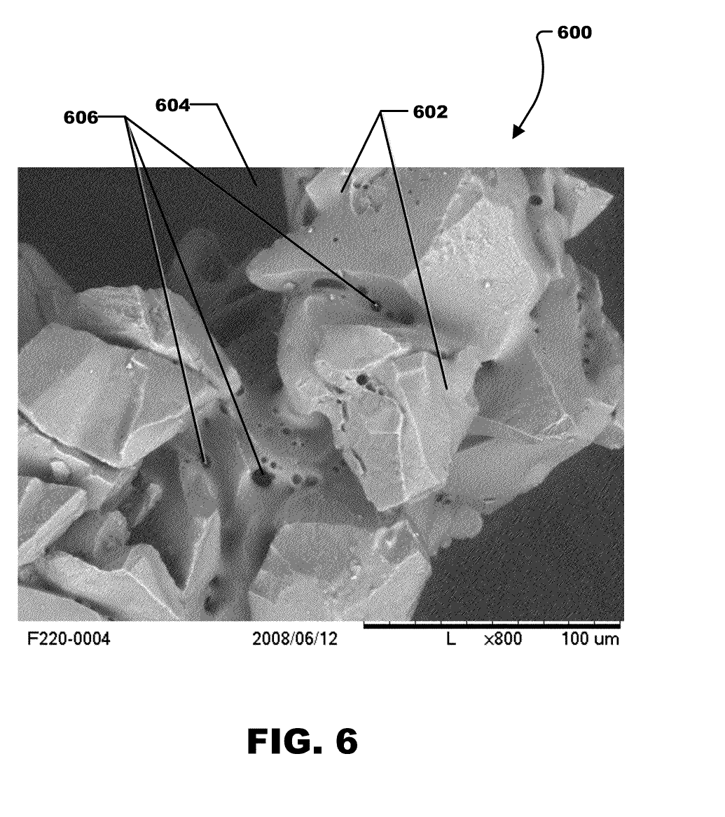

Referring to FIG. 6, another SEM image is presented and is designated 600. The SEM image 600 shown in FIG. 6 is an SEM image of an abrasive aggregate comprising silicon carbide particles having a grit size of approximately 63 microns according to an embodiment. The SEM image 600 of FIG. 6 was taken at a magnification of 800× and shows a portion of an abrasive aggregate. As shown, the abrasive aggregate includes silicon carbide particles 602 contained within a binder material 604. Further, the abrasive aggregate includes a plurality of pores 606.

As shown, the pores 606 can have an average pore size of at least about 1 micron. Further, the pores 606 can have an average pore size of at least about 2 microns, such as at least about 3 microns, at least about 4 microns, or at least about 5 microns. The pores 606 can have an average pore size no greater than about 10 microns, no greater than about 15 microns, or even no greater than about 20 microns. It will be appreciated that the average pore size may be in a range between any of the minimum and maximum values noted above.

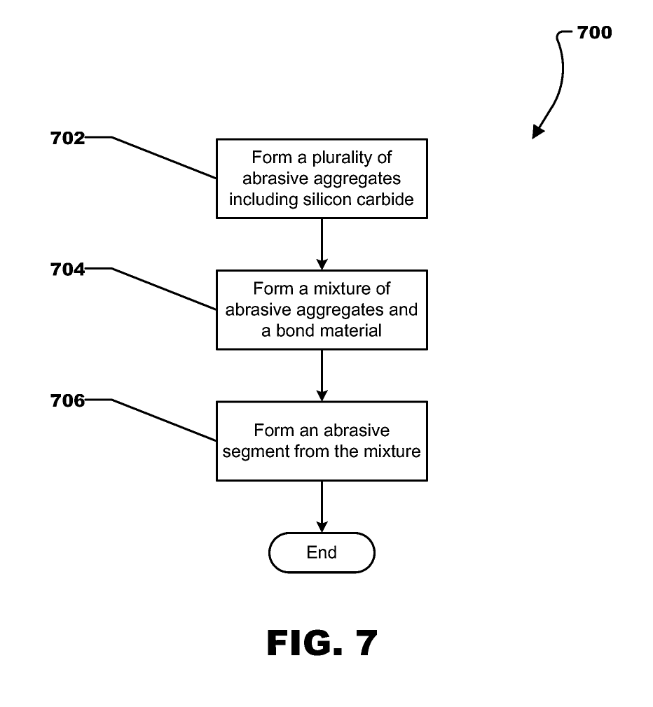

Referring now to FIG. 7, a method of making an abrasive segment is shown and is generally designated 700. The method 700 can be commenced at block 702 by forming a plurality of abrasive aggregates that include silicon carbide. In a particular aspect, the abrasive aggregates may be formed as described herein in conjunction with FIG. 1. Further, the abrasive aggregates may include one or more of the material properties described herein.

The method 700 can continue at block 704 by forming a mixture of abrasive aggregates and a bond material. The bond material can include a cement, and particularly, the bond material can include a magnesia-based cement. In one embodiment, the bond material may consist essentially of a magnesia-based cement.

The magnesia-based cement can include a magnesium oxide. Further, the magnesia-based cement can include a magnesium chloride. Moreover, the magnesia-based cement may include a magnesium oxide and a magnesium chloride. For example, the magnesia-based cement can include a ratio of magnesium oxide to magnesium chloride. In particular, the ratio of magnesium oxide to magnesium chloride can be at least about 2.5:1, at least about 2.6:1, at least about 2.7:1, at least about 2.8:1, at least about 2.9:1, or at least about 3.0:1. Further, the ratio of magnesium oxide to magnesium chloride can be no greater than about 3.5:1, about 3.4:1, about 3.3:1, or about 3.2:1. It will be appreciated that the ratio of magnesium oxide to magnesium chloride may be within a range between any of the minimum and maximum ratios noted above.

After forming the mixture at 704, the method 700 may continue at block 706 by forming an abrasive segment from the mixture. In a particular embodiment of the present disclosure, the abrasive segment may be formed by techniques including, but not limited to, pressing, casting, pouring, molding, cutting, extruding, or a combination thereof. Further, the abrasive segment may be formed by curing the mixture, for example, after the mixture is pressed, poured, molded, cut, extruded, or a combination thereof.

In a particular aspect, the mixture may cure at a temperature of at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., or at least about 80° C. In another aspect, the mixture may cure at a temperature of no greater than about 100° C., no greater than about 95° C., no greater than about 90° C., or no greater than about 85° C. It will be appreciated that the curing temperature may be within a range between any of the minimum and maximum temperatures noted above.

In another particular aspect, the mixture may cure for at least about 1 week, at least about 2 weeks, or at least about 3 weeks. In still another aspect, the mixture may cure for no greater than about 8 weeks, no greater than about 6 weeks, or no greater than about 4 weeks. It will be appreciated that the curing time may be within a range between any of the minimum and maximum times noted above.

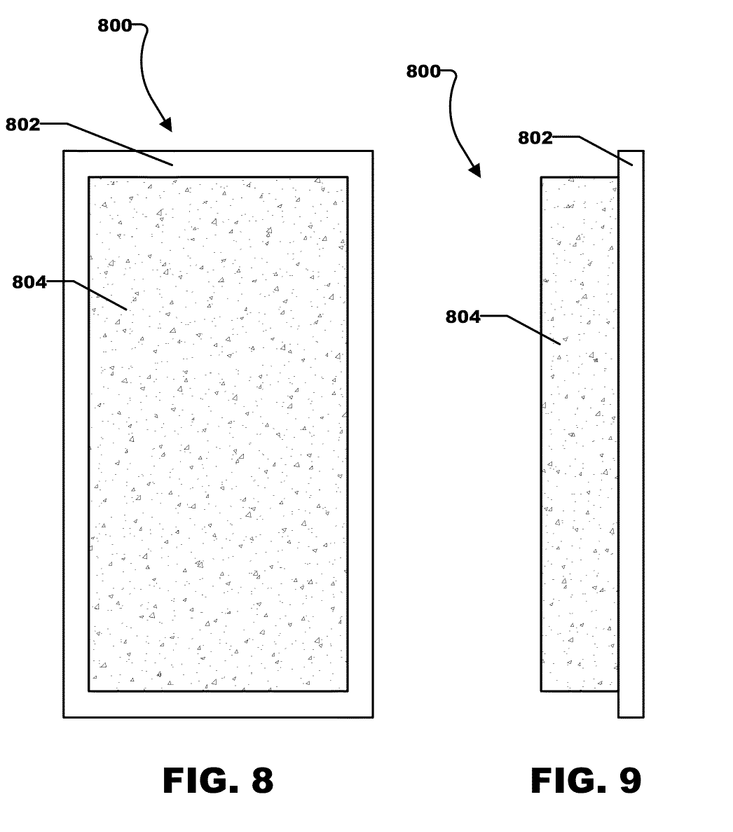

FIG. 8 and FIG. 9 include illustrations of an abrasive segment, generally designated 800. As shown, the abrasive segment 800 can include a substrate 802 and an abrasive body 804 affixed, or otherwise attached, to the substrate 802. FIG. 8 and FIG. 9 indicate that the body 804 of the abrasive segment 800 may be generally prismatic and may have a generally rectangular cross-section. However, it will be appreciated that other geometries can be used. The abrasive body 804 can include features of the abrasive segments described in conjunction with embodiments included herein. It will be appreciated that the abrasive body 804 can include abrasive aggregates including silicon carbide that are suitable for conducting material removal procedures, such as a polishing operation.

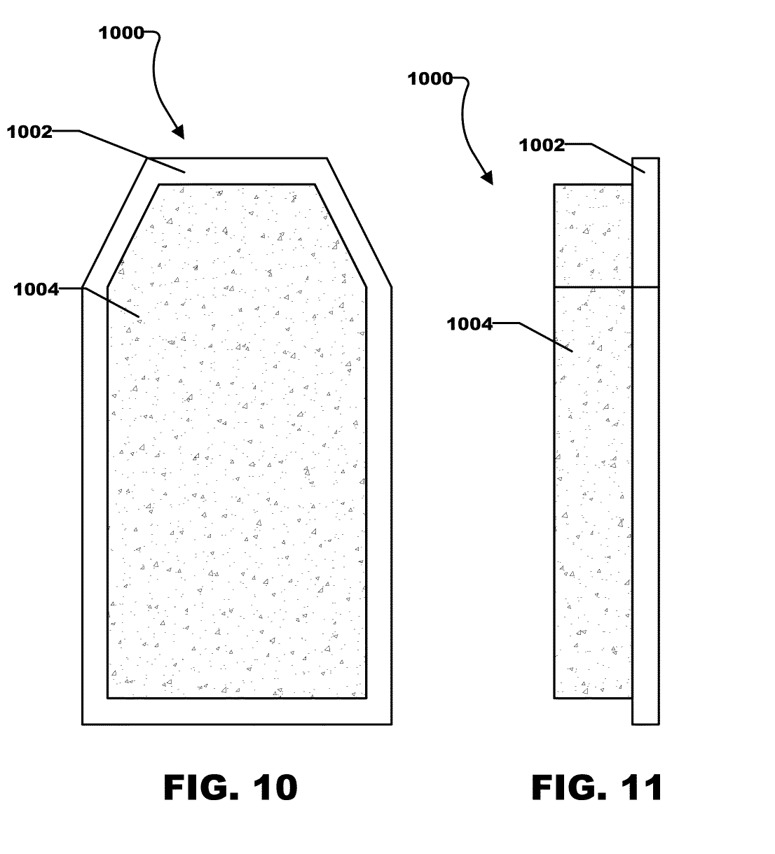

FIG. 10 and FIG. 11 illustrate a second embodiment of an abrasive segment, designated 1000. The abrasive segment 1000 shown in FIG. 10 and FIG. 11 can include a substrate 1002 and an abrasive body 1004 affixed to the substrate 1002. The abrasive body 1004 can include features of the abrasive segments described in conjunction with embodiments included herein. It will be appreciated that the abrasive body 1004 can include abrasive aggregates including silicon carbide that are suitable for conducting material removal procedures, such as a polishing operation.

The abrasive segment 1000 shown in FIG. 10 and FIG. 11 may have the corners of one end of the abrasive segment 1000 removed in order to facilitate radially attaching several abrasive segments 1000 to a polishing head (not shown). In the embodiment, shown in FIG. 10 and FIG. 11 the corners of adjacent ends of the substrate 1002 and the body 1004 may be removed.

The substrate 802, 1002 can be made from a metal or a metal alloy. For example, the substrate can include aluminum. In another aspect, the substrate can include steel.

In other instances, the substrate 802, 1002 can be made from an organic material. The organic material may include a resilient organic material. Further, the organic material can include a polymer including for example, a high density polyethylene (HDPE).

Further, the body 804, 1004 of each abrasive segment 800, 1000 may include a plurality of abrasive aggregates according to embodiments herein. The abrasive aggregates can be contained within a bond material that includes a cement and particularly, a magnesia-based cement, according to embodiments herein.

In another particular aspect, the body 804, 1004 of each abrasive segment 800, 1000 can include no greater than about 30 wt % abrasive aggregates for the total segment weight, no greater than about 25 wt % abrasive aggregates, no greater than about 20 wt % abrasive aggregates, or no greater than about 15 wt % abrasive aggregates. In another aspect, the body 804, 1004 of each abrasive segment 800, 1000 can include at least about 1 wt % abrasive aggregates, at least about 5 wt % abrasive aggregates, or at least about 10 wt % abrasive aggregates. It can be appreciated that each abrasive segment 800, 1000 may include a body 804, 1004 only and the weight of the substrate may not contribute to the total segment weight described above. In such an embodiment, the total segment weight is the same as the total body weight. It will be appreciated that the amount of abrasive aggregates including silicon carbide may be within a range between any of the minimum and maximum percentages noted above.

In a particular aspect, the body 804, 1004 of each abrasive segment 800, 1000 can include at least about 70 wt % bond material for the total segment weight, at least about 75 wt % bond material, at least about 80 wt % bond material, or at least about 85 wt % bond material. In another aspect, the body 804, 1004 of each abrasive segment 800, 1000 can include no greater than about 99 wt % bond material, no greater than about 95 wt % bond material, or no greater than about 90 wt % bond material. It will be appreciated that the amount of bond material may be within a range between any of the minimum and maximum percentages noted above.

In another aspect, a ratio of bond material to the abrasive aggregates in the body 804, 1004 of the abrasive segment 800, 1000 is at least about 2.3:1. In another aspect, the ratio is at least about 3:1, at least about 4:1, at least about 5.7:1, or at least about 9:1. The ratio of bond material to the abrasive aggregates may no be greater than about 99:1, no greater than about 19:1, or no greater than about 15:1. It will be appreciated that the ratio of bond material to abrasive aggregates may be within a range between any of the minimum and maximum ratios noted above.

In a particular aspect, the abrasive segments 800, 1000, for example, the bodies 804, 1004 thereof, can include a porosity that is no greater than about 5 vol % of a total segment volume, such no greater than about 4 vol %, no greater than about 3 vol %, or no greater than about 2 vol %. In another aspect, the porosity is at least about 0.5 vol %, at least about 1.0 vol % of a total segment volume, or at least about 1.5 vol % of a total segment volume. It will be appreciated that the porosity may be within a range between any of the minimum and maximum percentages noted above.

In another aspect, the abrasive aggregates including silicon carbide can be uniformly distributed throughout a volume of the binder material.

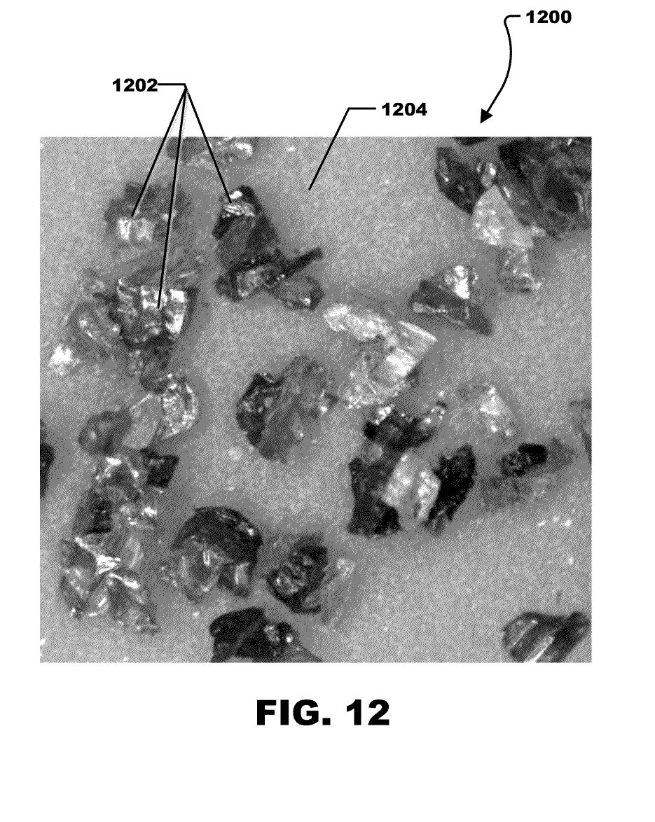

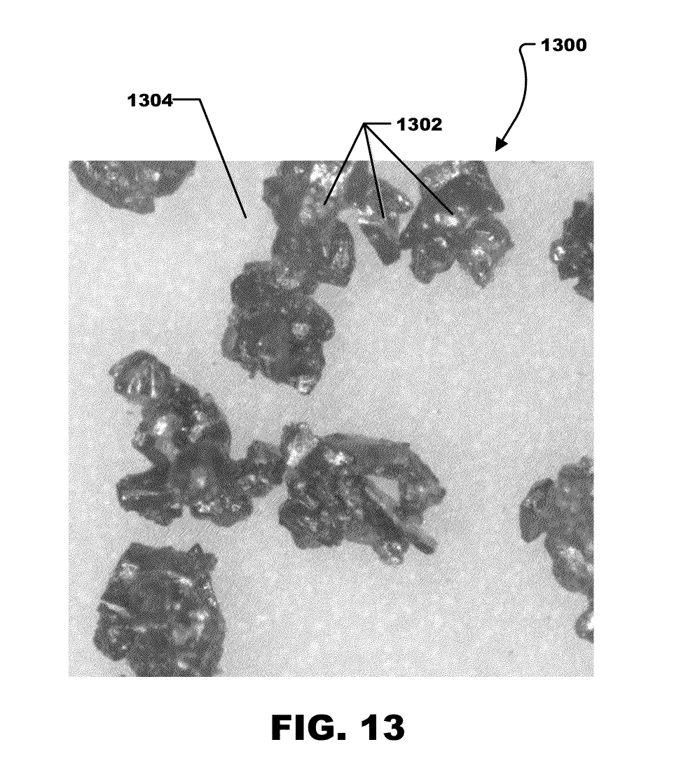

FIG. 12 and FIG. 13 include illustrations of SEM images of bodies of abrasive segments, such as the bodies 804, 1004 of the abrasive segments 800, 1000. The SEM image 1200 of FIG. 12 shows a plurality of abrasive aggregates 1202 according to embodiments herein dispersed in a binder material 1204 according to embodiments herein. Similarly, the SEM image 1300 of FIG. 13 shows a plurality of abrasive aggregates 1302 according to embodiments herein dispersed in a binder material 1304 according to embodiments herein.

In a particular aspect, the SEM images 1200, 1300 indicate that the bodies of the abrasive segments can define an average aggregate-to-aggregate distance between two adjacent abrasive aggregates 1202, 1302. Further, the bodies of the abrasive segments can define an average particle-to-particle distance between two adjacent silicon carbide particles within any particular abrasive aggregate. In particular, the particle-to-particle distance is significantly less than the aggregate-to-aggregate distance.

In one particular aspect, the particle-to-particle distance is no greater than about 90% of the aggregate-to-aggregate distance. In another embodiment, the particle-to-particle distance is no greater than about 80% of the aggregate-to-aggregate distance, no greater than about 70%, no greater than about 60%, no greater than about 50%, no greater than about 40%, no greater than about 35%, no greater than about 30%, no greater than about 25%, no greater than about 20%, no greater than about 15%, no greater than about 10%, or no greater than about 5%. In another aspect, the particle-to-particle distance is at least about 0.1% of the aggregate-to-aggregate distance, at least about 1% of the aggregate-to-aggregate distance, or at least about 2% of the aggregate-to-aggregate distance. It will be appreciated that the percentage of the particle-to-particle distance relative to the aggregate-to-aggregate distance may be within a range between any of the minimum and maximum percentages noted above.

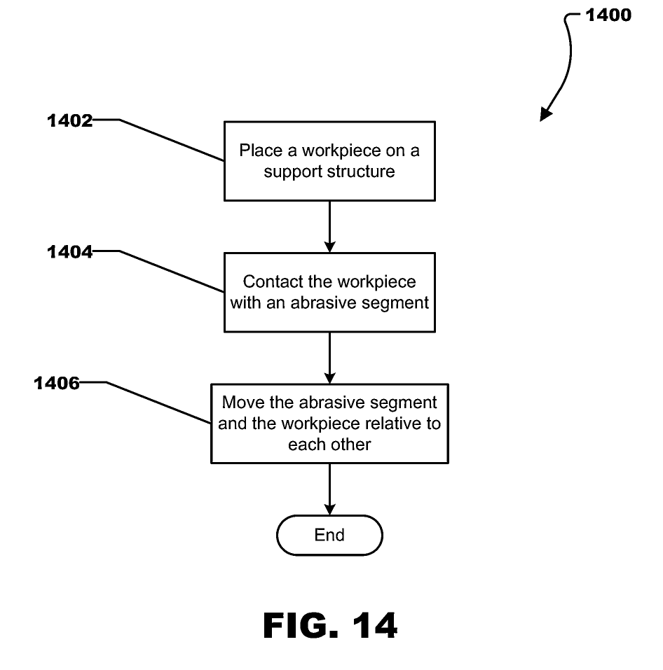

Referring now to FIG. 14, a method of polishing a workpiece is shown and is generally designated 1400. As shown, the method 1400 can commence at block 1402 by placing a workpiece on a support structure. At block 1404, the method 1400 can include contacting the workpiece with an abrasive segment.

Moreover, at block 1406, the method 1400 can include moving the abrasive segment and the workpiece relative to each other to facilitate a material removal process. In particular, the workpiece and the abrasive segment can move relative to each other in a linear direction. Alternatively, the abrasive segment and the workpiece can move relative to each other in a rotary direction. Further, in another aspect, the abrasive segment and the workpiece can move relative to each other in a direction that combines linear motion and rotary motion.

In a particular embodiment, the workpiece may include a stone material. Further, the stone material may be selected from the group consisting of marble, granite, and limestone. In other cases, the workpiece can include a ceramic material. In another aspect, the workpiece may have a hardness of at least about 3.0 on the Mohs hardness scale or at least about 4.0 on the Mohs hardness scale. In still another aspect, the workpiece may have a hardness no greater than about 6.0 on the Mohs hardness scale or no greater than about 5.0 on the Mohs hardness scale. It will be appreciated that the hardness may be in a range between any of the minimum and maximum values noted above.

During the material removal process, the workpiece and the abrasive segment may contact each other under a particular contact force. The contact force can be applied to the abrasive segment, the workpiece, or a combination thereof. In one embodiment, the contact force can be at least about 1 kg per square centimeter, at least about 1.5 kg per square centimeter, or at least about 2.0 kg per square centimeter. In another aspect, the contact force may be no greater than about 5.0 kg per square centimeter, no greater than about 4.5 kg per square centimeter, or no greater than about 3.0 kg per square centimeter. It will be appreciated that the contact force may be within a range between any of the minimum and maximum forces noted above.

In an additional embodiment, a particular pressure can be applied to the workpiece with the abrasive segment. For example, the pressure exerted on the workpiece can be no greater than about 35 psi, no greater than about 29 psi, or no greater than about 25 psi. In other aspects, the pressure exerted on the workpiece by the abrasive segment can be at least approximately 5 psi, at least approximately 11 psi, or at least approximately 15 psi. It will be appreciated that the pressure exerted on the workpiece can be within a range between any of the minimum and maximum values noted above.

Further, in another aspect, the abrasive segment and the workpiece can move relative to each other at a grinding speed of at least about 50 revolutions per minute, at least about 100 RPM, at least about 250 RPM, at least about 300 RPM, or at least about 400 RPM. In another aspect, the abrasive segment and the workpiece can move relative to each other at a grinding speed no greater than about 750 RPM, no greater than about 600 RPM, or no greater than about 550 RPM. It will be appreciated that the grinding speed may be within a range between any of the minimum and maximum speeds noted above.

In a particular aspect, the workpiece can have a surface roughness (Ra) after polishing of no greater than about 10 μm, no greater than about 8 μm, no greater than about 6 μm, or no greater than about 4 μm. In another aspect, the workpiece can have a surface roughness after polishing of at least about 0.01 μm, at least about 0.05 μm, or at least about 0.1 μm. It will be appreciated that the surface roughness may be within a range between any of the minimum and maximum surface roughness values noted above.

It will be appreciated that the surface roughness (Ra) is a measure of the texture of a surface. The surface roughness is quantified by the vertical deviations of a real surface from its ideal form. The average surface roughness, Ra, is expressed in units of height.

In an embodiment, a duration of the polishing operation can be at least approximately 5 minutes, at least approximately 11 minutes, or at least approximately 15 minutes. In another embodiment, the duration of the polishing operation can be no greater than approximately 45 minutes, no greater than approximately 30 minutes, or no greater than approximately 18 minutes. It will be appreciated that the duration of the grinding operation can be within a range between any of the minimum and maximum values noted above.

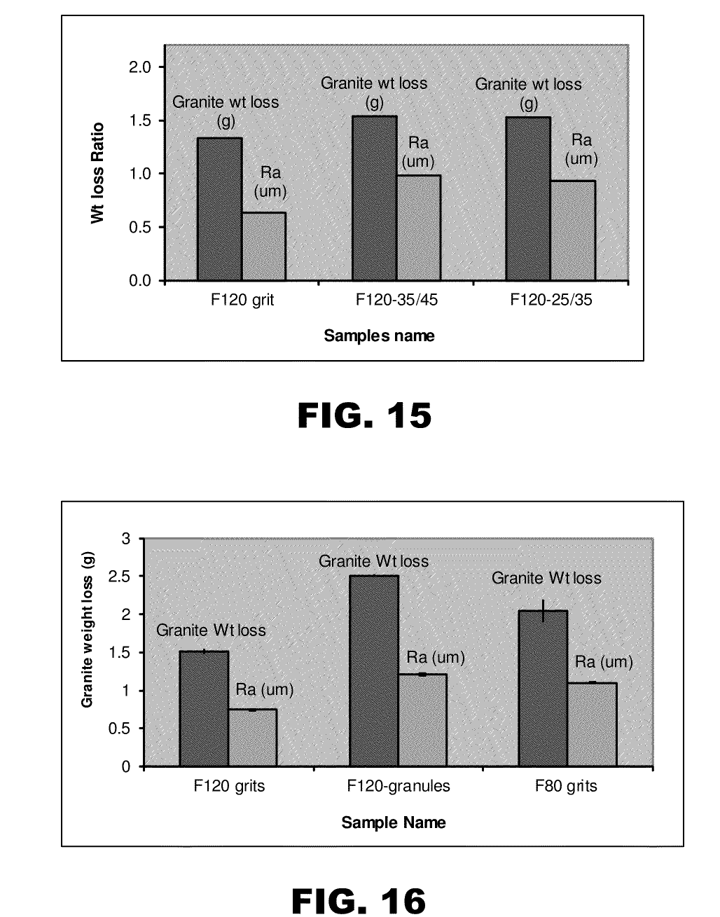

FIG. 15 and FIG. 16 illustrate test results for two different stone polishing tests. Each test was conducted on a stone lapping machine in which an abrasive segment rotated and orbited relative to a workpiece. The stone polishing tests were conducted according to embodiments of the method 1400 of FIG. 14.

FIG. 15 illustrates the test results for a first stone polishing test in which three different abrasive segments were tested under substantially the same conditions. Each abrasive segment includes the same formulation of a magnesia-based binder material, wherein a ratio of MgO:H₂O:(MgCl₂.6H₂0)=13:13.5:1. However, each sample includes a different abrasive. The first sample includes silicon carbide grits having a grit size of approximately 110 microns according to one or more embodiments described herein. The second sample includes abrasive aggregates of approximately 355-500 microns in size made from silicon carbide grits having a grit size of approximately 110 microns. The third sample includes abrasive aggregates of approximately 500-710 microns in size made from silicon carbide grits having a grit size of approximately 110 microns. Each sample was used to polish a granite workpiece for a predetermined duration.

As shown in FIG. 15, after the test was completed for the first sample, the granite experienced a weight loss of about 1.3 grams and included a post-polishing surface roughness of approximately 0.6 μm. Using the second sample resulted in a granite weight loss of about 1.55 grams and a surface roughness of approximately 1.0 μm. Further, the third sample resulted in a granite weight loss of about 1.5 grams and a surface roughness of approximately 0.9 μm.

FIG. 16 illustrates the test results for a second stone polishing test in which three different abrasive segments were tested under substantially the same conditions. Each abrasive segment includes the same formulation of a magnesia-based binder material, wherein a ratio of MgO:H₂O:(MgCl₂.6H₂0)=10:13:1. However, each sample includes a different abrasive. The first sample includes silicon carbide grits having a grit size of approximately 110 microns. The second sample includes abrasive aggregates having a size of approximately 110 microns and formed from silicon carbide grits. The third sample includes silicon carbide grits having a grit size of approximately 190 microns.

As shown in FIG. 16, after the test was completed for the first sample, the granite experienced a weight loss of about 1.5 grams and included a post-polishing surface roughness of approximately 0.75 μm. Using the second sample resulted in a granite weight loss of about 2.5 grams and a surface roughness of approximately 1.25 μm. Further, the third sample resulted in a granite weight loss of about 2.0 grams and a surface roughness of approximately 1.1 μm.

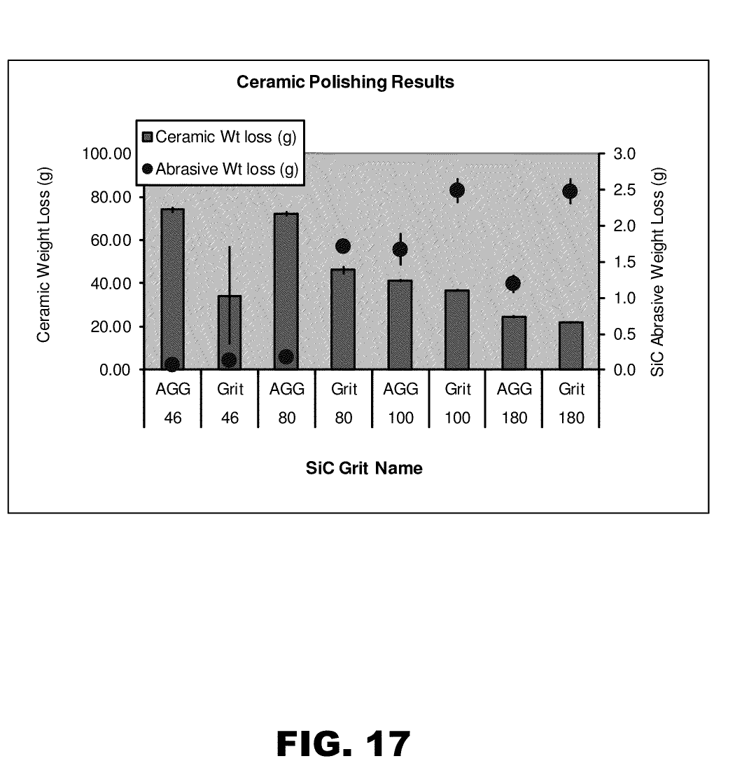

FIG. 17 shows the results for a ceramic polishing comparison test for eight different samples. FIG. 17 plots the ceramic weight loss vertically from 0 to 100 grams and the abrasive weight loss vertically from 0 to 3 grams for four pairs of samples. Each sample includes the same formulation of a magnesia-based binder material, wherein a ratio of MgO:H₂O:(MgCl₂.6H₂0)=13:13.5:1. The polishing operation was conducted according to embodiments of the method 1400 of FIG. 14.

The first sample comprises abrasive aggregates contained within the binder material. The abrasive aggregates include silicon carbide particles having a grit size of approximately 370 microns. The second sample comprises free silicon carbide particles having a grit size of approximately 370 microns. The third sample comprises abrasive aggregates having silicon carbide particles having a grit size of approximately 190 microns. The fourth sample comprises free silicon carbide particles having a grit size of approximately 190 microns. The fifth sample comprises abrasive aggregates having silicon carbide particles having a grit size of approximately 129 microns. The sixth sample comprises free silicon carbide particles having a grit size of approximately 129 microns. The seventh sample comprises abrasive aggregates having silicon carbide particles having a grit size of approximately 69 microns. The eighth sample comprises free silicon carbide particles having a grit size of 69 microns.

As shown, after testing was completed, the ceramic weight loss for the first sample was approximately 75 grams and the abrasive weight loss for the first sample was approximately 0.1 grams. The ceramic weight loss for the second sample was approximately 35 grams and the abrasive weight loss for the second sample was approximately 0.15 grams.

Further, as illustrated in FIG. 17, after testing, the ceramic weight loss for the third sample was approximately 70 grams and the abrasive weight loss for the third sample was approximately 0.2 grams. The ceramic weight loss for the fourth sample was approximately 48 grams and the abrasive weight loss for the fourth sample was approximately 1.7 grams.

After testing, the ceramic weight loss for the fifth sample was approximately 40 grams and the abrasive weight loss for the fifth sample was approximately 1.6 grams. The ceramic weight loss for the sixth sample was approximately 38 grams and the abrasive weight loss for the sixth sample was approximately 2.5 grams.

Additionally, after testing, the ceramic weight loss for the seventh sample was approximately 25 grams and the abrasive weight loss for the seventh sample was approximately 1.2 grams. The ceramic weight loss for the eighth sample was approximately 21 grams and the abrasive weight loss for the second sample was approximately 2.5 grams.

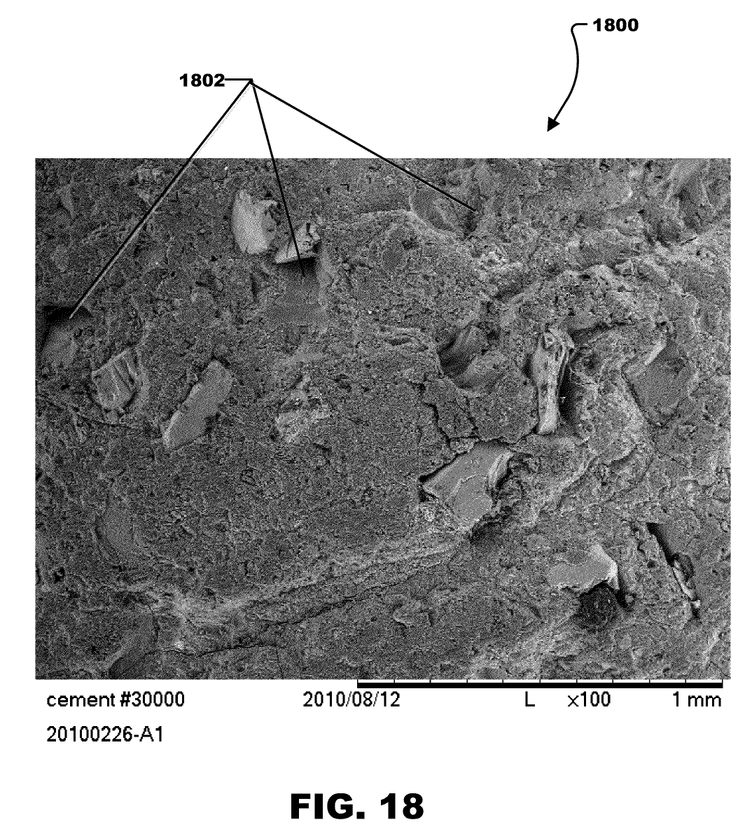

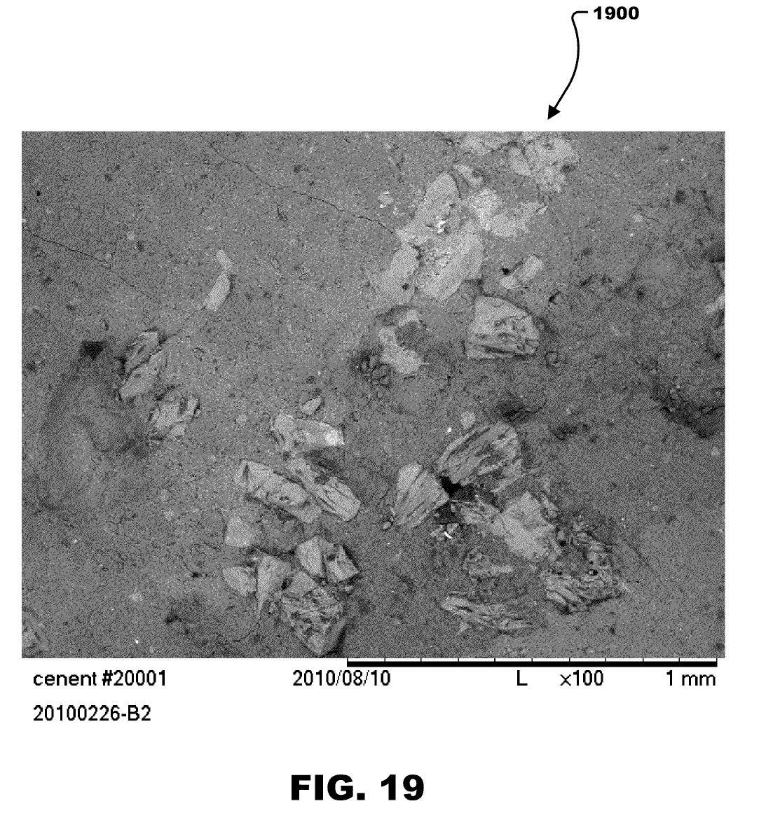

FIG. 18 is an SEM image 1800 of a portion of a used abrasive segment containing silicon carbide grits in a magnesia-based binder material. The abrasive segment is considered used in that the abrasive segment was used to polish, or otherwise finish, a workpiece for a predetermined duration. As shown in the SEM image 1800, the abrasive segment includes a plurality of voids 1802 in which silicon carbide grits were previously disposed. These silicon carbide grits pulled out of the binder material during the polishing operation and contributed to a relatively high abrasive weight loss as shown in the test results discussed above.

FIG. 19 is an SEM image 1900 of a portion of a used abrasive segment containing abrasive aggregates having silicon carbide in a magnesia-based cement binder material. The abrasive segment is considered used in that the abrasive segment was used to polish, or otherwise finish, a workpiece for a predetermined duration. As shown in the SEM image 1900, the abrasive segment includes relatively fewer voids when compared to the SEM image 1800 of FIG. 18 indicating that the abrasive aggregates were less likely to pull out during a polishing operation than free silicon carbide grits.

The methods described herein for forming abrasive aggregates and abrasive segments are a departure from the state-of-the-art and produce abrasive aggregates and abrasive segments that have improved performance over conventional silicon carbide abrasives, such as free silicon carbide grains. In particular, the methods of forming abrasive aggregates described herein can provide high yields of useful abrasive aggregates that have desirable physical properties, such as crush strength. Previous attempts to form silicon carbide aggregates often resulted in oxidation of the silicon carbide and produced clusters of material that were not useable as an abrasive. In addition, the combination of certain features, such as the porosity of the abrasive aggregates and the amount of binder material, can provide an unexpectedly improved performance over the use of individual silicon carbide particles as an abrasive for grinding operations. Without being bound to a particular theory, the improved grinding performance of tools using abrasive agglomerates formed as described herein can be attributed to the porosity of the abrasive agglomerates and strength of the binding material allowing for the exposure of new abrasive material to the workpiece as abrasive material is consumed.

Further, abrasive tools formed with abrasive aggregates as described herein can have an improved performance over tools using free silicon carbide particles as an abrasive. For example, the use of a magnesia-based cement as a material to bond the silicon carbide abrasive aggregates can help provide improved grinding of workpieces. Unexpectedly, the magnesia-based cement can have a synergistic effect with the abrasive aggregates such that the abrasive agglomerates do not pull out of the magnesia-based cement during grinding as easily as free silicon carbide grains. Accordingly, the performance of tools utilizing the abrasive aggregates bound by the magnesia-based cement is improved over free silicon carbide grains bonded by the magnesia-based cement.

### EXAMPLES

Abrasive aggregates are formed using the materials and amounts shown in Table 1. The abrasive aggregates of samples 1-3 are made using silicon carbide abrasive grains having an average particle size within a range of about 145 microns to about 155 microns. The abrasive aggregates of samples 4-6 are made using silicon carbide abrasive grains having an average particle size within a range of about 172 microns to about 183 microns. The abrasive content can include certain impurities or minor amounts of other abrasives, such as a walnut shell abrasive in the case of samples 2-6.

Sample 1 is made by combining the materials in a Rippon mixer and mixed for a duration within a range of about 5 minutes to about 10 minutes. After the mixing operation, a pre-screening operation is performed by a suitable vibratory screener. The materials are then subject to a drying procedure on a vibratory hot plate at temperatures within a range of about 150° C. to about 250° C. The dried particles are sintered in a tunnel kiln using plates as a transport medium to form abrasive aggregates. The sintering operation takes place at a sintering temperature within a range of about 930° C. to about 970° C. for a duration within a range of about 38 minutes to about 42 minutes. The sintered abrasive aggregates are then screened. The screening process provides abrasive aggregates having an average particle size within a range of about 200 microns to about 850 microns.

Samples 2-6 are made by combining the materials in an Eirich mixer and mixed for a duration within a range of about 5 minutes to about 10 minutes. After the mixing operation, the materials are subject to a drying procedure on a vibratory hot plate at temperatures within a range of about 150° C. to about 250° C. A wet pre-screening operation is not performed for samples 2-6. The dried particles are sintered in a tunnel kiln using saggers as a transport medium to form abrasive aggregates. The sintering operation takes place at a sintering temperature within a range of about 930° C. to about 970° C. for a duration within a range of about 1 hour to about 2 hours. The sintered abrasive aggregates are then screened. For samples 2 and 3, the screening process provides abrasive aggregates having an average particle size within a range of about 200 microns to about 850 microns. For samples, 4-6, the screening process provides abrasive aggregates having an average particle size within a range of about 250 microns to about 1000 microns.

TABLE 1

| | | Bond | | |
|---|---|---|---|---|
| Sample | Abrasive (wt %) | (wt %) | Dextrin (wt %) | Water (wt %) |
| 1 | 93% | 4% | 2% | 1% |
| 2 | 87.5% | 4% | 4.5% | 4% |
| 3 | 86% | 4.5% | 5% | 4.5% |
| 4 | 86.5% | 4.5% | 4.5% | 4.5% |
| 5 | 87.5% | 4.5% | 4.0% | 4.0% |
| 6 | 88% | 4% | 4% | 4% |

Useful yield and crush strength are measured for samples 1-6. The results are shown in Table 2. The useful yield indicates abrasive aggregates having about 5 to 500 single abrasive grains. The crush strength is determined by placing the abrasive aggregates into about a 1 inch diameter cylindrical matched die mold to a depth of about 1 inch. The mold is placed into a Carver press and compressed at a rate of about 0.2 in./min. At a specified peak force, the test is stopped and the abrasive aggregates are removed. The abrasive aggregates are then sifted to determine a degree of crushing. The crush fraction is determined based on an amount of debris passing through a screen of a specified size. For samples 1-3, the crush fraction is determined by measuring the amount of debris that passes through a screen having a size within a range of about 350 microns to about 500 microns. For samples 4-6, the crush fraction is determined by measuring the amount of debris that passes through a screen having a size within a range of about 500 microns to about 710 microns.

TABLE 2

| Sample | Useful Yield | Crush Strength |
|---|---|---|
| 1 | 75% | 60% |
| 2 | 77% | 89% |
| 3 | 73% | 80% |
| 4 | 70% | 89% |
| 5 | 73% | 94% |
| 6 | 64% | 91% |

The above-disclosed subject matter is to be considered illustrative, and not restrictive, and the appended claims are intended to cover all such modifications, enhancements, and other embodiments, which fall within the true scope of the present invention. Further, it may be appreciated that one or more features of a particular aspect or embodiment may be combined with one or more features of another aspect or embodiment to yield a combination of structure not specifically shown or described herein.

1. An abrasive article, comprising:
an abrasive aggregate comprising a plurality of silicon carbide particles bonded together by a binder material, the binder material comprising a vitreous phase material and a crystalline phase material.

2. The abrasive article of claim 1, wherein the silicon carbide particles comprise an average primary particle size of no greater than about 1500 microns.

3. (canceled)

4. (canceled)

5. The abrasive article of claim 1, wherein the abrasive aggregate comprises an average aggregate size of at least about 50 microns.

6. The abrasive article of claim 1, wherein the abrasive aggregate comprises at least about 50 wt % silicon carbide for a total weight of the abrasive aggregate.

7. (canceled)

8. (canceled)

9. (canceled)

10. The abrasive article of claim 1, wherein the abrasive aggregate comprises no greater than about 50 wt % binder material for a total weight of aggregate.

11. The abrasive article of claim 1, wherein the abrasive aggregate comprises at least about 50 wt % vitreous phase material for a total weight of the binder material.

12. (canceled)

13. The abrasive article of claim 1, wherein the abrasive aggregate comprises at least about 50 wt % crystalline phase material for a total weight of the binder material.

14. (canceled)

15. The abrasive article of claim 1, wherein the crystalline phase material comprises a sodium aluminosilicate.

16. (canceled)

17. (canceled)

18. (canceled)

19. The abrasive article of claim 1, wherein the crystalline phase material comprises crystallites have an average crystallite size of no greater than about 100 microns.

20. The abrasive article of claim 1, wherein the crystalline phase material comprises crystallites having an average crystallite size of at least about 2 microns.

21. (canceled)

22. The abrasive article of claim 1, wherein the abrasive aggregate comprises a porosity not greater than about 60 vol % of a total volume of the abrasive aggregate.

23. An abrasive article, comprising:
an abrasive aggregate comprising a plurality of silicon carbide particles bonded together by a binder material, the binder material comprising a crystalline phase including an aluminosilicate material.

24. (canceled)

25. A method of making an abrasive aggregate, comprising:
forming a mixture comprising silicon carbide particles, a binder material, and a liquid carrier; and
placing green granules comprising silicon carbide particles, the binder material, and the liquid carrier from the mixture on a platen while the platen is vibrated and heated.

26. (canceled)

27. (canceled)

28. (canceled)

29. (canceled)

30. (canceled)

31. (canceled)

32. (canceled)

33. (canceled)

34. (canceled)

35. The method of claim 25, further comprising shaping the green granules by moving the green granules through a screen, wherein the screen comprises a US mesh size of at least about 8 and no greater than about 25.

36. (canceled)

37. (canceled)

38. (canceled)

39. The method of claim 25, wherein the green granules remain on the platen for at least about 5 minutes and no greater than about 60 minutes.

40. The method of claim 25, wherein the platen is heated to a temperature of at least about 80° C. and no greater than about 300° C., at least about 110° C., or at least about 150° C.

41. (canceled)

42. The method of claim 25, wherein the platen oscillates at a frequency of at least about 10 cycles per second and no greater than about 120 cycles per second.

43. (canceled)

44. (canceled)

45. (canceled)

46. (canceled)

47. (canceled)

48. The method of claim 25, further comprising:
treating the green granules in the a kiln to form the abrasive aggregates.

49. The method of claim 48, wherein treating the green granules comprises sintering the green granules.

50. (canceled)

51. (canceled)

52. (canceled)

53. (canceled)

54. (canceled)

55. (canceled)

56. (canceled)

57. The method of claim 48, further comprising:
crushing the abrasive aggregates to form crushed abrasive aggregates.

58. (canceled)

59. (canceled)

60. (canceled)
